(19) United States
(12) Patent Application Publication
(10) Pub. No.: US 2020/0206597 A1
(43) Pub. Date: Jul. 2, 2020

(54) VIRTUAL SPORTS SIMULATION DEVICE

(71) Applicant: SGM CO., LTD., Seongnam-si Gyeonggi-do (KR)

(72) Inventors: Ui Bum LEE, Seongnam-si Gyeonggi-do (KR); Kap Su KIM, Seoul (KR); Jae Won HER, Seoul (KR); Jae Hun GWAG, Seoul (KR)

(21) Appl. No.: 16/639,729

(22) PCT Filed: Jul. 26, 2018
(86) PCT No.: PCT/KR2018/008474

§ 371 Date: Feb. 17, 2020

(30) Foreign Application Priority Data
Aug. 24, 2017 (KR) 10-2017-0107067
Oct. 23, 2017 (KR) 10-2017-0137095

(51) Int. Cl. A63B 71/06; G03B 21/608

(52) U.S. Cl. CPC A63B 71/0622; A63B 69/3661; G03B 21/608

(57) ABSTRACT

The present inventive concept provides a virtual sports simulation device comprising a screen and a control part. The screen displays a background picture for a virtual sport and a virtual ball, and a control part performs simulation about a trajectory of the virtual ball based on a result of hitting a real ball if a user hits the real ball. The virtual ball is displayed on the screen after the real ball hit by the user collides with the screen and the virtual ball on the screen moves along the simulated trajectory.

### TECHNICAL FIELD

The present disclosure relates to a virtual sports simulation device. More particularly, according to the virtual sports simulation device of the present disclosure, a ball hit by a user passes through a screen to disappear after colliding with the screen, and thus it can give a feeling that the ball is sucked into the screen to be displayed on the screen. As a result, the real hit of the user is naturally connected to the picture in the screen so that the gap between the real world and the virtual world is reduced and the user can feel as if playing real sports games outside.

### BACKGROUND ART

Recently, simulation apparatuses for enjoying sports games without having to go to a sports field have been developed by using 3D stereoscopic image and computer simulation technology so that virtual indoor sports games such as golf or baseball have come into wide use. For example, in the case of screen golf played indoors, images of a golf course are displayed through a screen. Therefore, it can give the feeling of playing a real golf game outside, and time and money can be saved in comparison with the play at an outdoor field. As a result, the screen golf is very popular among busy modern people who have difficulty in playing a real outdoor golf due to time or economic reasons, etc.

In virtual sports such as screen golf or screen baseball, one of the most important factors that can appeal to users is whether or not the users can have the feeling of really playing golf outside. In screen sports such as screen golf and screen baseball, the hit of the ball by the user is similar to the hit in real play outdoors, but after hitting the ball there is a significant difference between the screen sports and the real sports. In the real sports, the player sees how the ball hit by him or her moves. However, in the screen sports, once the player hits the ball, he or she is not interested in the movement of the hit ball, and the player concentrates on only the virtual ball displayed on the screen. In the screen sports, the user's attention is suddenly switched to the picture displayed on the screen, and thus the real world based on the real hit of the user is not connected naturally to the virtual world shown on the screen so that there is the gap between the real world and the virtual world. Therefore, in screen sports, there is a limit to giving the user the feeling of really playing sports games outside.

### DISCLOSURE

### Technical Problem

Considering the above mentioned problems, the present inventive concept provides a virtual sports simulation device making a user feel as if really playing sports games outside by giving the feeling that a ball is sucked into a screen after the collision between the ball and the screen to be displayed on the screen.

In addition, the present inventive concept provides a virtual sports simulation device using a transmission type screen. By using this transmission type screen, a ball hit by a user passes through a screen and disappears from the user's view to give the user a stronger feeling that a ball is sucked into a screen.

The other objects of the present inventive concept will be clearly understood with reference to the following detailed description and the accompanying drawings.

### Technical Solution

In order to the above mentioned objects, a virtual sports simulation device according to an embodiment of the present inventive concept comprises a screen and a control part. The screen displays a background picture for a virtual sport and a virtual ball, and the control part performs simulation about a trajectory of the virtual ball based on a result of hitting a real ball if a user hits the real ball. The virtual ball is displayed on the screen after the real ball hit by the user collides with the screen and the virtual ball on the screen moves along the simulated trajectory.

In the virtual sports simulation device, the virtual ball begins to appear at a site where the real ball collides with the screen or near the site when the virtual ball is displayed.

A virtual sports simulation device according to another embodiment of the present inventive concept comprises a screen and a control part. The screen displays a background picture for a virtual sport and a virtual ball, and the control part performs simulation about a trajectory of the virtual ball based on a result of hitting a real ball if a user hits the real ball. If a position where the virtual ball is initially located in the simulated trajectory is called an initial position and a position where the virtual ball is located in the trajectory after a predetermined time elapses from the initial position is called an intermediate position, the trajectory between the initial position and the intermediate position is not displayed on the screen, and the virtual ball on the screen moves along the simulated trajectory after the intermediate position.

In the virtual sports simulation device, the elapsed time corresponds to time period between when the user hits the real ball and when the real ball collides with the screen.

In the virtual sports simulation device, the virtual ball is displayed on the screen after the real ball hit by the user collides with the screen.

In the virtual sports simulation device, the virtual ball begins to appear at a site where the real ball collides with the screen or near the site when the virtual ball is displayed.

In the virtual sports simulation device, the background picture shown on the screen moves horizontally and/or vertically when the real ball collides with the screen, in order that the virtual ball is displayed on the screen at the site where the real ball collides with the screen or near the site.

In the virtual sports simulation device, an angle where the background picture is viewed on the screen is changed when the real ball collides with the screen, in order that the angle corresponds to a direction where the real ball collides with the screen.

In the virtual sports simulation device, the virtual ball is displayed on the screen before the user hits the real ball, disappears from the screen after the user hits the real ball, and is displayed on the screen again after the real ball hit by the user collides with the screen.

In the virtual sports simulation device, the virtual sport is screen baseball or screen golf.

A virtual sports simulation device according to another embodiment of the present inventive concept comprises a control part and a screen. The control part performs simulation about a trajectory of a virtual ball based on a result of hitting a real ball if a user hits the real ball, and the screen displays a background picture for a virtual sport and the virtual ball moving along the simulated trajectory. The screen is a transmission type screen where the real ball hit by the user can pass.

In the virtual sports simulation device, the screen is a liquid screen comprising a spray part spraying liquid forming a screen film, a recovery part recovering the sprayed liquid and a supply part providing the liquid to be sprayed from the spray part to the spray part.

In the virtual sports simulation device, the screen is a mist screen comprising a spray part spraying mist forming a screen film, a recovery part recovering the sprayed mist and a supply part providing liquid for forming the mist to the spray part.

In the virtual sports simulation device, the virtual ball is displayed on the screen after the real ball hit by the user collides with the screen, and the virtual ball on the screen moves along the simulated trajectory.

In the virtual sports simulation device, the virtual ball begins to appear at a site where the real ball collides with the screen or near the site when the virtual ball is displayed. In order that the virtual ball is displayed on the screen at the site where the real ball collides with the screen or near the site, the background picture shown on the screen moves horizontally and/or vertically when the real ball collides with the screen.

In the virtual sports simulation device, an angle where the background picture is viewed on the screen is changed when the real ball collides with the screen, in order that the angle corresponds to a direction where the real ball collides with the screen.

In the virtual sports simulation device, the virtual ball is displayed on the screen before the user hits the real ball, disappears from the screen after the user hits the real ball, and is displayed on the screen again after the real ball hit by the user collides with the screen.

In the virtual sports simulation device, if a position where the virtual ball is initially located in the simulated trajectory is called an initial position and a position where the virtual ball is located in the trajectory after a predetermined time elapses from the initial position is called an intermediate position, the trajectory between the initial position and the intermediate position is not displayed on the screen, and the virtual ball on the screen moves along the simulated trajectory after the intermediate position.

In the virtual sports simulation device, the elapsed time corresponds to time period between when the user hits the real ball and when the real ball collides with the screen.

In the virtual sports simulation device, the virtual ball is displayed on the screen after the real ball hit by the user collides with the screen.

In the virtual sports simulation device, the virtual ball begins to appear at a site where the real ball collides with the screen or near the site when the virtual ball is displayed. In order that the virtual ball is displayed on the screen at the site where the real ball collides with the screen or near the site, the background picture shown on the screen moves horizontally and/or vertically when the real ball collides with the screen.

In the virtual sports simulation device, an angle where the background picture is viewed on the screen is changed when the real ball collides with the screen, in order that the angle corresponds to a direction where the real ball collides with the screen.

In the virtual sports simulation device, the virtual ball is displayed on the screen before the user hits the real ball, disappears from the screen after the user hits the real ball, and is displayed on the screen again after the real ball hit by the user collides with the screen.

### ADVANTAGEOUS EFFECTS

According to a virtual sports simulation device of the present inventive concept, the gap between a real world and a virtual world is reduced and a user can feel as if playing real sports outside by giving the feeling that a ball hit by the user penetrate a screen after the collision between the ball and the screen, and is sucked into the screen to be displayed on the screen.

### DESCRIPTION OF DRAWINGS

FIG. 1 shows a schematic structure of a virtual golf simulation device according to an embodiment of the present inventive concept.

FIG. 2 shows a schematic structure of a virtual baseball simulation device according to another embodiment of the present inventive concept. FIGS. 3 to 19 are views for describing examples of various operating methods of the virtual golf simulation device of FIG. 1.

FIG. 20 shows a schematic structure of a virtual golf simulation device using a transmission type screen according to another embodiment of the present inventive concept.

FIG. 21 shows a relationship between main components of the virtual golf simulation device of FIG. 20.

FIG. 22 is shows a configuration of a liquid screen as an example of a screen that can be used in the virtual golf simulation device of FIG. 20, and FIG. 23 shows a detailed structure of a spray part in the liquid screen of FIG. 22.

FIG. 24 is shows a configuration of a mist screen as an example of a screen that can be used in the virtual golf simulation device of FIG. 20, and FIG. 25 shows a detailed structure of a spray part in the mist screen of FIG. 24.

FIGS. 26 to 42 are views for describing examples of various operating methods of the virtual golf simulation device of FIG. 20.

### BEST MODE

Hereinafter, a detailed description will be given of the present inventive concept with reference to the following embodiments. The purposes, features, and advantages of the present inventive concept will be easily understood through the following embodiments. The present inventive concept is not limited to such embodiments, but may be modified in other forms. The embodiments to be described below are nothing but the ones provided to bring the disclosure of the present inventive concept to perfection and assist those skilled in the art to completely understand the present inventive concept. Therefore, the following embodiments are not to be construed as limiting the present inventive concept.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. It will be understood that when an element is referred to as being “on” another element, it can be directly on the other element or intervening elements may be present therebetween.

The size of the element or the relative sizes between elements in the drawings may be shown to be exaggerated for more clear understanding of the present inventive concept. In addition, the shape of the elements shown in the drawings may be somewhat changed by variation of the manufacturing process or the like. Accordingly, the embodiments disclosed herein are not to be limited to the shapes shown in the drawings unless otherwise stated, and it is to be understood to include a certain amount of variation.

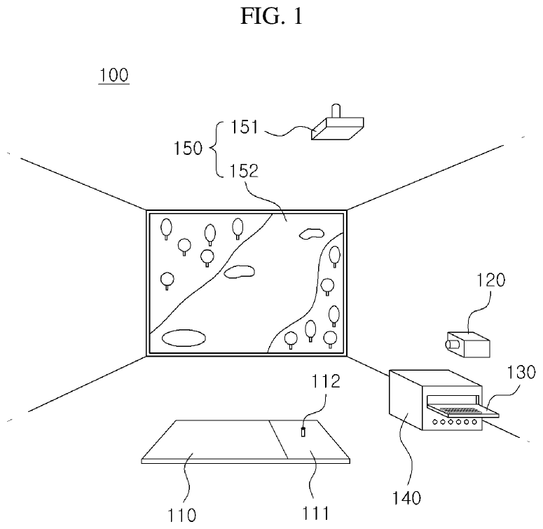

FIG. 1 shows a schematic structure of a virtual golf simulation device according to an embodiment of the present inventive concept.

Referring to FIG. 1, the virtual golf simulation device 100 comprises a hitting plate 110, a sensing part 120, an input part 130, a control part 140 and a display part 150.

The hitting plate 110 falls under a hitting zone where a golf ball for hitting is located. The hitting plate 110 is provided with a hitting mat 111, and an auto tee 12 having a vertically movable structure is installed at the hitting mat 111. The golf ball for hitting is provided to a user through the auto tee 112.

The sensing part 120 senses the movement of the golf ball hit by the user to detect overall state information about the hit golf ball. As the sensing part 120, a camera capable of sensing the movement of the golf ball can be used. In addition, if it can sense the movement of the golf ball, any sensing means such as a sensor can be used as the sensing part 120. The camera or the sensor may be used alone or used together, and only one sensing units may be used or several sensing unit may be used if circumstances need.

The input part 130 receives information from the user. As the input part 130, a keyboard or a mouse can be used. In the screen golf, the information input by the user is needed for various cases. For example, when selecting a golf course for playing or a play difficulty level, the user needs to input the related information. The input part 130 is provided for this object.

The control part 140 receives the overall state information about the hit golf ball from the sensing part 120 when the user hits the golf ball, and then computes the trajectory of the golf ball based on the received information by simulation.

The display part 150 includes a display unit 151 and a screen 152. In order that virtual golf course and virtual golf ball are displayed on the screen 152, the display unit 151 performs processing for related images and provides the images. The display unit 151 may include a device such as a beam projector. The screen 152 displays the golf-related images to provide them to the user. The virtual golf course displayed on the screen 152 may have various areas like real golf course. For example, the virtual golf course may include a fairway, a rough, a bunker, a water hazard and the like.

Although not shown in FIG. 1, a voice processing unit may be provided to inform the user of the progress of the game and to play various sound effects in accordance with the progress of the game.

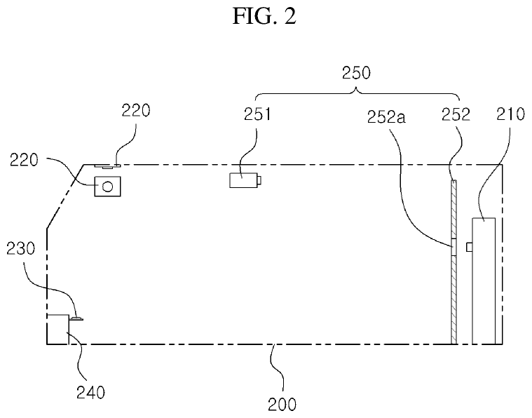

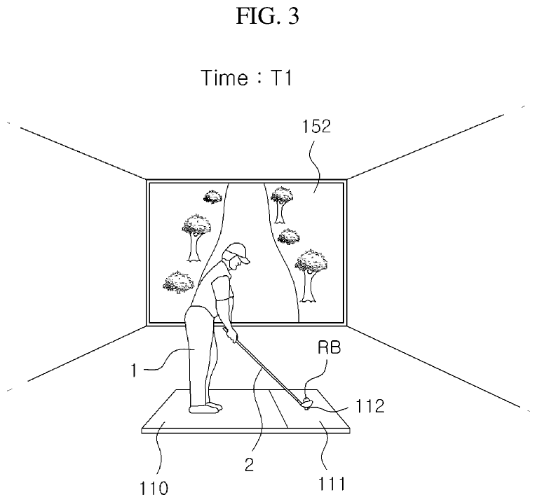

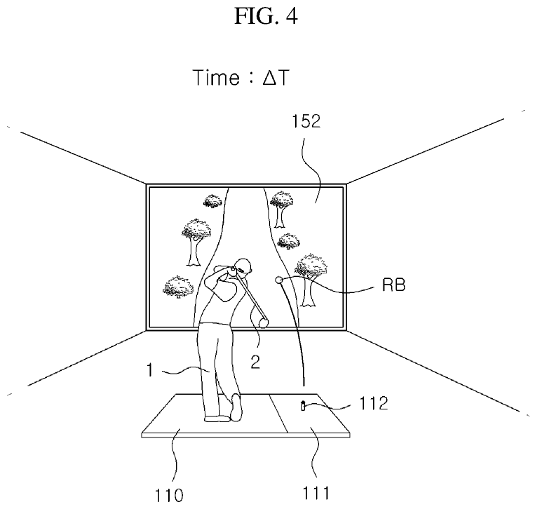

FIG. 2 shows a schematic structure of a virtual baseball simulation device according to another embodiment of the present inventive concept.

Referring to FIG. 2, the virtual baseball simulation device 200 comprises a pitching machine 210, a sensing part 220, an input part 230, a control part 240 and a display part 250.

The pitching machine 210 provides a baseball for hitting to the user. The pitching machine 210 is spaced apart from the hit position of the user (near the position where the control part 240 is located) by a predetermined distance, and the baseball provided to the user by the pitching machine 210 is flying at a predetermined speed like a baseball thrown by a pitcher.

The sensing part 220 senses the pose of the user at the time of hitting the baseball or the movement of the baseball ball hit by the user. As the sensing part 220, a camera capable of sensing the pose of the user or the movement of the baseball can be used. In addition, if it can sense the movement of the baseball, any sensing means such as a sensor can be used as the sensing part 220. The camera or the sensor may be used alone or used together, and only one sensing unit may be used or several sensing units may be used if circumstances need. In order to capture the moment when the user hits, it is preferable that the camera or the sensor is disposed above the vicinity of the user's hit position.

The input part 230 receives information from the user. As the input part 230, a keyboard or a mouse can be used. In the screen baseball, the information input from the user is needed for various cases. For example, when inputting the password or ID of the user, or selecting a play difficulty level, the user needs to input the related information. The input part 230 is provided for this object.

The control part 240 receives the information sensed by the sensing part 220, and then computes the trajectory of the baseball based on the received information by simulation. The image where the baseball moves along with the computed trajectory is displayed by the display part 250. In addition, the control part 240 checks the information input by the user through the input part 230 and performs a necessary operation accordingly. For example, when the user selects the play difficulty level as ‘easy’, the control part 240 may control the pitching machine 210 to throw the baseball with low speed.

The display part 250 includes a display unit 251 and a screen 252. The display unit 251 performs processing for images to be displayed on the screen 152 and provides them. The display unit 251 may include a device such as a beam projector. The screen 252 displays the baseball-related images such as a baseball field, a pitcher and defensive players to provide them to the user. The screen 252 is disposed in front of the pitching machine 210 in the view of the user. Therefore, the pitching machine 210 is hidden from the screen 252 and is not visible to the user. When the baseball is provided to the user from the pitching machine 210, the baseball passes through the screen 252 to reach the user. The screen 252 has a through hole 252a, and the baseball from the pitching machine 210 can pass through the screen 252 due to the through hole 252a.

Although not shown in FIG. 2, a voice processing unit may be provided to inform the user of the progress of the game and to play various sound effects in accordance with the progress of the game.

Both the virtual golf simulation device of FIG. 1 and the virtual baseball simulation device of FIG. 2 can give the feeling that the ball hit by the user is sucked into the screen after the collision between the ball and the screen to be displayed on the screen, and a specific operation method is used for this effect as below explained. For this explanation, the operation of the virtual golf simulation device has been described as an example, but the operation method described below is applicable to the virtual baseball simulation device or other virtual sports simulation device.

FIGS. 3 to 19 are views for describing examples of various operating methods of the virtual golf simulation device of FIG. 1. FIGS. 3 to 5 show a first operation method, FIGS. 6 to 8 show a second operation method, FIGS. 9 to 11 show a third operation method, FIGS. 14 to 16 show a fourth operation method, and FIGS. 17 to 19 show a fifth operation method.

### First Operation Method

Referring to FIG. 3, a screen golf player 1 (hereinafter referred to as a ‘screen golfer’) is located at the hitting plate 110 with a golf club 2 and a real golf ball RB is placed on the auto tee 12 of the hitting mat 111. For your reference, in relation to a golf ball mentioned herein, in order not to confuse a real golf ball actually hit by the screen golfer 1 and a virtual golf ball displayed on the screen 152, the real golf ball and the virtual golf ball are marked with different reference numerals (real golf ball: RB, virtual golf ball: VB).

In FIG. 3, the golf club 2 is contact with the real golf ball RB, and this moment is when or just before the screen golfer 1 hits the ball for a tee off.

Referring FIGS. 4 and 5, the screen golfer 1 completes the swing, and the hit golf ball RB moves forward and collides with the screen 152. When the real golf ball RB collides with the screen 152, the virtual golf ball VB is displayed on the screen 152 after the collision. If the virtual golf ball VB is displayed immediately after the collision, it may be shown with the naked eye that the virtual golf ball VB is displayed at the same time as the collision. It is possible for the virtual golf ball VB to be displayed at the same time as the collision. However, there is no significant difference between displaying the virtual golf ball VB at the same time as the collision and displaying the virtual golf ball VB immediately after the collision in that it is not distinguished with the naked eye. Therefore, what is described as ‘after the collision’ herein may even include ‘at the same time as the collision’ in some cases.

As described above, the virtual golf simulation device according to the present embodiment is characterized in that the virtual golf ball VB is not displayed on the screen 152 immediately after the real golf ball RB is hit (see FIG. 4), and the virtual golf ball VB is displayed on the screen 152 immediately after the real golf ball RB hits the screen 152.

In other words, if the time point when the real golf ball RB is hit is called a first time T1, the time period taken for the real golf ball RB to fly at the first time T1 and collide with the screen 152 is called a flight time ΔT, and the time point when the real golf ball RB collides with the screen 152 is called a second time T2 (T2=T1+ΔT) (T1, ΔT, T2 are used in the same meaning in other embodiments described later), the operational feature according to the present embodiment is that the virtual golf ball VB is not displayed on the screen 152 during the flight time ΔT.

The effect of this feature is as follows.

Real and virtual worlds are mixed in the screen golf. The action that the screen golfer 1 actually hits the real golf ball RB represents the real world since this action is not different with a hit action made in an outdoor golf course. On the other hand, the movement of the golf ball after hitting the golf ball represents the virtual world since the movement of the golf ball is not made by the real golf ball RB and is shown by the virtual golf ball VB in the screen 152. If the virtual golf ball VB is displayed on the screen 152 during the flight time ΔT, the screen golfer 1 becomes indifferent about how the real golf ball RB moves after hitting the real golf ball RB and pays only attention to the movement of the virtual golf ball VB displayed on the screen 152. That is, before and after hitting the real golf ball RB, the interest of the screen golfer 1 is suddenly switched from the real world to the virtual world. If the interest of the screen golfer 1 is suddenly switched like this, the real world and the virtual world are disconnected from each other and the gap therebetween is increased. As a result, it is difficult for the screen golfer 1 to feel as if playing real sports games in the outdoor golf course.

However, if the virtual golf ball VB is not displayed on the screen 152 during the flight time ΔT according to the present embodiment, the screen golfer 1 pays attention to not the screen 152 but the movement of the real golf ball RB even after hitting the real golf ball RB. When the real golf ball RB collides with the screen 152, the eye of the screen golfer 1 is naturally moved to the screen 152, and thus the screen golfer 1 pays attention to the movement of the virtual golf ball VB displayed on the screen 152 at that moment. As a result, the interest of the screen golfer 1 naturally flows from the real world to the virtual world to reduce the gap between the real world and the virtual world. Therefore, it makes the screen golfer 1 strongly feel as if playing real sports games in the outdoor golf course.

According to the operation method, since the virtual golf ball VB begins to be displayed after the real golf ball RB collides with the screen 152, it is necessary to detect the collision between the real golf ball RB and the screen 152. Therefore, a detection sensor for detecting the collision between the real golf ball RB and the screen 152 is required. Although not shown in the drawing, as one example of the detection sensor, a sensor for detecting a sound generated due to the collision between the real golf ball RB and the screen 152 may be used. As another example of the detection sensor, a sensor for detecting an impact on the screen 152 resulting from the collision may be used. Alternatively, a visual sensor such as a camera that can visually detect the collision between the real golf ball RB and the screen 152 may be used. This visual sensor can detect not only whether or not the real golf ball RB collides with the screen 152, but also additional information such as the collision position, the collision direction meaning the moving direction of the real golf ball RB at the time of the collision. This additional information may be used in second to fifth operation methods described later. However, even though there is no detection sensor, it is possible to get the additional information through calculation if it is necessary. For example, after the screen golfer 1 hits the real golf ball RB, the state of the real golf ball RB such as speed, spin and the like is sensed in order to compute the trajectory of the virtual golf ball RB, and the above mentioned information such as the collision time, the collision position, the collision direction and the like can be calculated from the sensed information about the state of the hit real golf ball RB.

Since the present operation method presupposes that the real golf ball RB collides with the screen 152, if the real golf ball RB hit by the screen golfer 1 does not collide with the screen 152, the conventional operation method can be used instead of the present operation method.

### Second Operation Method

Referring to FIG. 6, the screen golf player 1 hits the real golf ball RB at the first time T1. When comparing with FIG. 3, there is a difference in that the real golf ball RB is placed on the hitting mat 111. In the case of the tee off, the golf player 1 hits the real golf ball RB placed on the auto tee (see reference numeral 112 in FIG. 3). However, in the case of the hit except for the tee off, the golf player 1 hits the real golf ball RB placed on the hitting mat 111. When comparing with FIG. 3, there is another difference in that the virtual golf ball VB is displayed on the screen 152. FIG. 6 shows a state where the screen golfer 1 makes a play after the tee off. In this state, the virtual golf ball VB is located at various regions (fairway, rough, bunker, etc.) on the virtual golf course depending on how the screen golfer 1 has played. As shown in FIG. 6, the virtual golf ball VB is displayed on the screen 152, and thus the screen golfer 1 can clearly know where the virtual golf ball VB corresponding to the real golf ball RB is currently located before hitting the real golf ball RB.

Referring to FIG. 7, immediately after the screen golfer 1 hit the real golf ball RB, the virtual golf ball VB disappears from the screen 152 and then the virtual golf ball VB is not displayed on the screen 152 during the flight time between the first time T1 and when the real golf ball RB collides with the screen 152.

Referring to FIG. 8, after the second time T2 when the real golf ball RB collides with the screen 152, the virtual golf ball VB is displayed again on the screen 152. This is identical to the first operation method shown in FIG. 5.

According to this embodiment, the virtual golf ball VB is displayed on the screen 152 before the real golf ball RB is hit so that the screen golfer 1 can clearly know where the virtual golf ball VB is located before hitting the real golf ball RB. In addition, by not displaying the virtual golf ball VB on the screen 152 for the flight time ΔT after hitting the real golf ball RB, it induces the screen golfer 1 to pay attention to the real golf ball RB instead of immediately averting her/his eyes to the screen 152. As a result, like the case of the first operation method, the gap between the real world and the virtual world is reduced and thus the screen golfer 1 can feel as if playing real sports outside.

### Third Operation Method

Referring to FIGS. 9 and 10, the operation at the first time T1 and during the flight time ΔT is identical to the second operation method. That is, the virtual golf ball VB is displayed on the screen 152 at the first time T1, and the virtual golf ball VB disappears from the screen 152 after the first time T1 and is not displayed during the flight time ΔT. Herein, it is possible that the operation at the first time T1 and during the flight time ΔT is modified to be similar to the first operation method so that the virtual golf ball VB is not displayed on the screen 152 from the first time T1.

Referring to FIG. 11, the virtual golf ball VB is displayed on the screen 152 immediately after the second time T2 when the real golf ball RB collides with the screen 152. In addition, the virtual golf ball VB begins to be displayed at the same position where the real golf ball RB collides with the screen 152 (In FIG. 11, the position of the virtual golf ball VB and the position of the real golf ball RB do not completely coincide with each other. FIG. 11 is intentionally drawn like this, considering that if two golf balls RB and VB overlap in FIG. 11, any one ball will be covered by the other ball to be invisible).

As described above, if the virtual golf ball VB appears on the screen 152 at the position where the real golf ball RB collides with the screen 152, it can give a feeling that, after the collision with the screen 152, the real golf ball RB is sucked into the screen 152 to be displayed as the virtual golf ball VB on the screen 152. As a result, the gap between the real world and the virtual world is greatly reduced and the user can strongly feel as if playing real sports outside.

FIGS. 12 and 13 show a modified example of the third operation method, respectively.

Referring to FIG. 12, the virtual golf ball VB begins to be displayed near the position where the real golf ball RB collides with the screen 152 (Hereinafter, the position where the real golf ball RB collides with the screen 152 is called ‘collision position’, and the position where the virtual golf ball VB starts to be displayed on the screen 152 after the real golf ball RB collides with the screen 15 is called ‘start position’). In order to give a feeling that the real ball RB is sucked into the screen 152 after the collision with the screen 152, it is preferable that the start position is identical to the collision position. However, it is not easy to make the start position and the collision position accurately coincide with each other. Since the size of the golf ball is not large, even if the virtual golf ball VB is displayed near the collision position, it is not easy to recognize that the start position is not different with the collision position with the naked eye. Therefore, it is preferable that the virtual golf ball VB is displayed near the collision point within a range where a person with average eyesight cannot recognize that the start position is not different with the collision position. Considering that this range may vary from person to person, as shown in FIG. 12, when the radius of the real golf ball RB is ‘R’, it is preferable that the start position is in the range of about 5R from the center of the golf ball RB. It is more preferable that the start position is in the range of about 3R.

Referring to FIG. 13, the background of the screen 152 is displayed on the screen 152 after moving horizontally and/or vertically at the time T2. In the third operation method, the virtual golf ball VB begins to be displayed on the screen 152 at or near the collision position where the real golf ball RB collided with the screen 152. Considering that the trajectory of the virtual golf ball VB is determined by the computation through the simulation of the control part (see reference numeral 140 in FIG. 1) and the start position where the virtual golf ball VB starts to be displayed is dependent on a position where the virtual ball is initially located in the simulated trajectory, it is likely that the start position is different the collision position. In order to match the start position with the collision position, the collision position must be moved to the start position or the start position must be moved to the collision position.

When the player hits the real golf ball RB, the real golf ball RB moves along the trajectory of the real golf ball RB formed based the player's hit to collide with the screen 152 and thus the collision position is determined. In this way, the collision position is dependent on the player's hit and cannot be changed arbitrarily. Therefore, it is impossible to move the collision position to the start position. In the case of the start position, since it is determined according to the trajectory computed through the simulation of the control part 140, it cannot be arbitrarily changed. However, it is possible to relocate the start position on the screen 152 by moving the background picture in the screen 152 as shown in FIG. 13. By using this way, it is possible to make the start position where the virtual golf ball VB starts to be displayed on the screen 152 corresponds to the collision position where the real golf ball RB collides with the screen 152.

For example, before moving the background picture of the screen 152, the start position and the collision position are different by ‘X’ in the horizontal direction and ‘Y’ in the vertical direction as shown in FIG. 13 (I). According to this operation method, the start position and the collision position become the same position by moving the background picture by ‘X’ in the horizontal direction and ‘Y’ in the vertical direction as shown in FIG. 13 (II) (In FIG. 13 (II), the position of the virtual golf ball VB and the position of the real golf ball RB do not completely coincide with each other. FIG. 13 (II) is intentionally drawn like this, considering that if two golf balls RB and VB overlap in FIG. 13 (II), any one ball will be covered by the other ball to be invisible).

As described above, the present modified example shows the operation method of matching the collision position with the start position by vertically and/or horizontally moving the background picture displayed on the screen 152.

### Fourth Operation Method

Referring to FIGS. 14 and 15, the operation at the first time T1 and during the flight time ΔT is identical to the second operation method. That is, the virtual golf ball VB is displayed on the screen 152 at the first time T1, and the virtual golf ball VB disappears from the screen 152 after the first time T1 and is not displayed during the flight time ΔT. Herein, it is possible that the operation at the first time T1 and during the flight time ΔT is modified to be similar to the first operation method so that the virtual golf ball VB is not displayed on the screen 152 from the first time T1.

Referring to FIG. 16, at the second time T2 when the real golf ball RB collides with the screen 152 or immediately after the second time T2, the virtual golf VB is displayed on the screen 152 and an angle where the background picture is viewed on the screen 152 is changed in order that the angle corresponds to a direction where the real ball RB collides with the screen 152.

As shown in FIG. 16 (I), if the collision direction (hereinafter, referred to as ‘collision direction’) where the real golf ball RB collides with the screen 152 differs greatly from the moving direction (hereinafter, referred to as ‘moving direction’) where the virtual golf ball VB displayed on the screen 152 moves, it can give the screen golfer 1 an unnatural feeling that the real golf ball RB is sucked into the screen 152 to be suddenly refracted in its direction. In order to prevent this unnatural feeling, it is preferable to match the collision direction where the real golf ball RB collides with the screen 152 and the moving direction where the virtual golf ball VB displayed on the screen 152 moves.

As explained with reference to FIG. 13, the movement of the real golf ball RB is dependent on the player's hit and cannot be changed arbitrarily. Likewise, the moving direction of the virtual golf ball VB cannot be arbitrarily changed. However, as shown in FIG. 16 (II), it is possible to change a viewing angle where the background picture is viewed on the screen 152. Changing the viewing angle has the same effect as changing the direction where the virtual golf ball VB moves on the screen 152. By using this way, it is possible to match the moving direction where the virtual golf ball VB displayed on the screen 152 moves and the collision direction where the real golf ball RB collides with the screen 152.

### Fifth Operation Method

The present operation method is related to how to simulate and compute the trajectory of the virtual golf ball VB to be displayed on the screen 152. The present operation method is different from the previous operation methods in that results according to this operation method are not clearly revealed to the screen golfer 1. The present operation method can be used alone or used in combination with at least one of the first to fourth operation methods. FIGS. 17 to 19 show an example that the present operation method is used in combination with the second operation method.

Referring to FIGS. 17 and 18, the operation at the first time T1 and during the flight time ΔT is identical to the second operation method. That is, the virtual golf ball VB is displayed on the screen 152 at the first time T1, and the virtual golf ball VB disappears from the screen 152 after the first time T1 and is not displayed during the flight time ΔT. Herein, it is possible that the operation at the first time T1 and during the flight time ΔT is modified to be similar to the first operation method so that the virtual golf ball VB is not displayed on the screen 152 from the first time T1.

Referring to FIG. 19, at the second time T2 when the real golf ball RB collides with the screen 152 or immediately after the second time T2, the virtual golf VB is displayed on the screen 152. The technical feature of this operation method relates to the trajectory of the virtual golf ball VB displayed on the screen 152. Concretely, when the real golf ball RB is hit at the first time T1 and the trajectory S for the virtual golf ball VB is computed as a result of the simulation based on the result of the player's hit result, and furthermore when the trajectory S includes a trajectory S1 corresponding to a trajectory between the first time T and a predetermined time and a trajectory S2 corresponding to a trajectory after the predetermined time, what is actually displayed on the screen 152 in the trajectory S is only the trajectory S2 except for the trajectory S1 according to the this operation method. For example, the predetermined time may be the second time T2 representing when the real golf ball RB collides with the screen 152. In this case, the trajectory S1 corresponds to a trajectory during the flight time ΔT (between the first time T1 and the second time T2) and the trajectory S2 corresponds to a trajectory after the second time T2, and only the trajectory S2 is displayed on the screen 152. That is, the virtual golf ball VB moving along the trajectory S1 is not displayed and the virtual golf ball VB moving along the trajectory S2 only is displayed.

Considering that the real golf ball RB flies from the hitting zone to the screen 152 during the flight time ΔT and the trajectory S1 corresponds to a trajectory during the flight time ΔT, the trajectory S1 is replaced by the real trajectory by the real golf ball RB flying to the screen 152 by omitting and not displaying the trajectory S1 of the entire simulated trajectory S in the present operation method. Therefore, the entire trajectory is represented by the real golf ball RB outside the screen 152 and the virtual golf ball VB in the screen 152. That is, the movement of the real golf ball RB is naturally connected to the movement of the virtual golf ball VB on the screen 152 and the trajectory of the real golf ball RB is also connected to the trajectory of the virtual golf ball VB. As a result, the screen golfer 1 can feel as if the real ball RB is sucked into the screen 152 and strongly feel as if playing real sports games in the outdoor golf course.

As above, although specific embodiments of the present inventive concept have been described, those skilled in the art will appreciate that the present inventive concept may be embodied in other specific ways without changing the technical spirit or essential features thereof. For example, the first to fifth operation methods can be applied not only to screen golf but also to screen baseball and other virtual sports devices. In addition, the first to fifth operating methods are not only used separately but also used in combination thereof. For example, the operation method of moving the background picture in order to match the start position with the collision position (see FIG. 13 and related description) can be combined with the operation method of rotating the background picture in order to match the moving direction with the collision direction (see FIG. 16 and related description).

The effect giving the feeling that the ball is sucked into the screen after the ball collides with the screen, is further increased by using a transmission type screen through which the ball can pass. Hereinafter, a description will be given of a virtual sports simulation device using a transmission type screen, and the case that the subject sport of the virtual sports simulation device is golf is taken as an example.

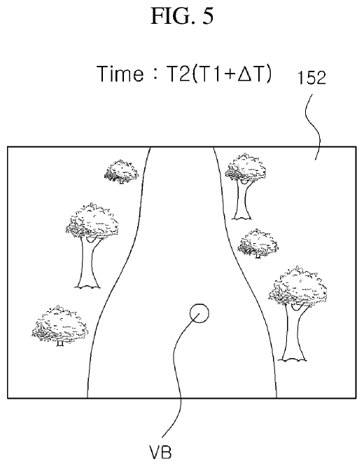

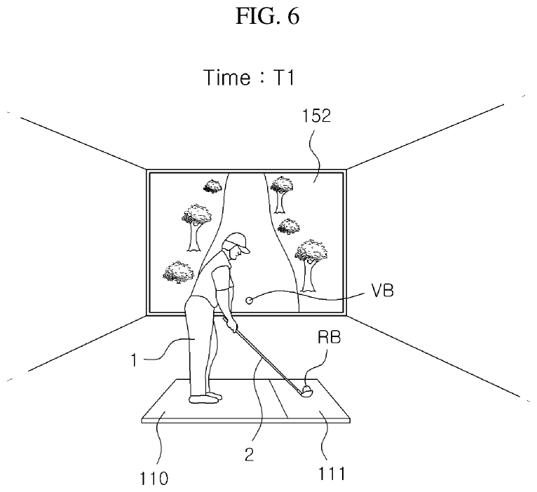

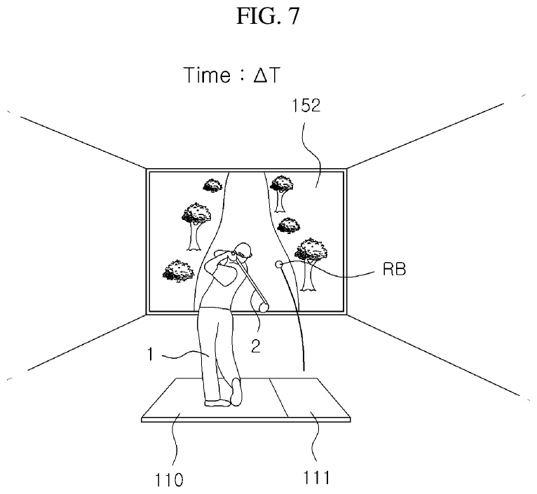

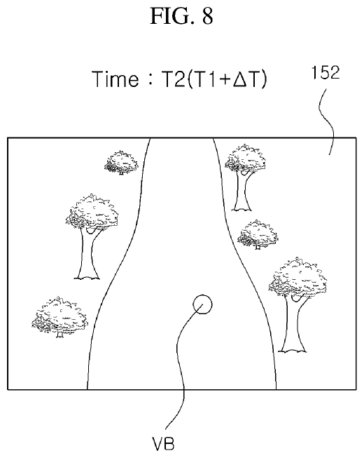

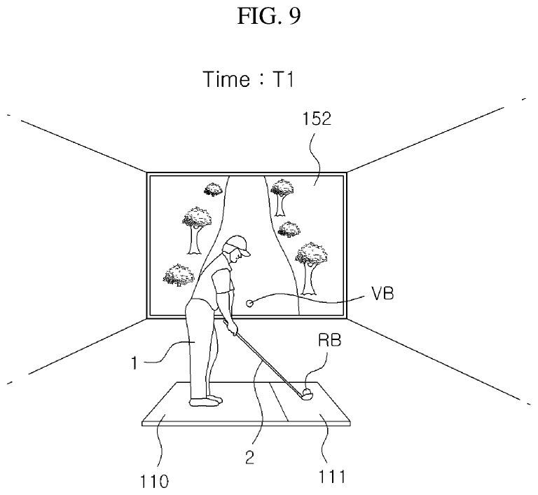

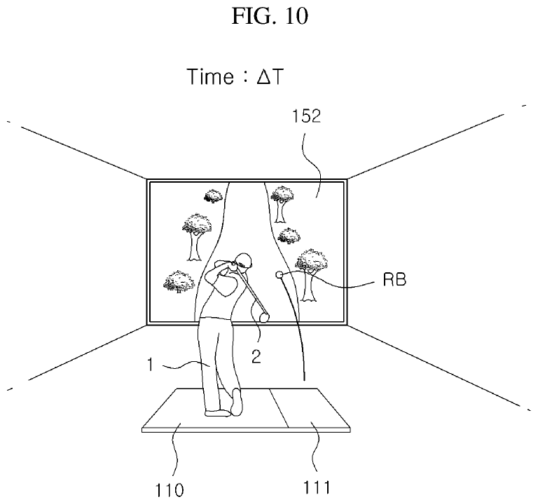

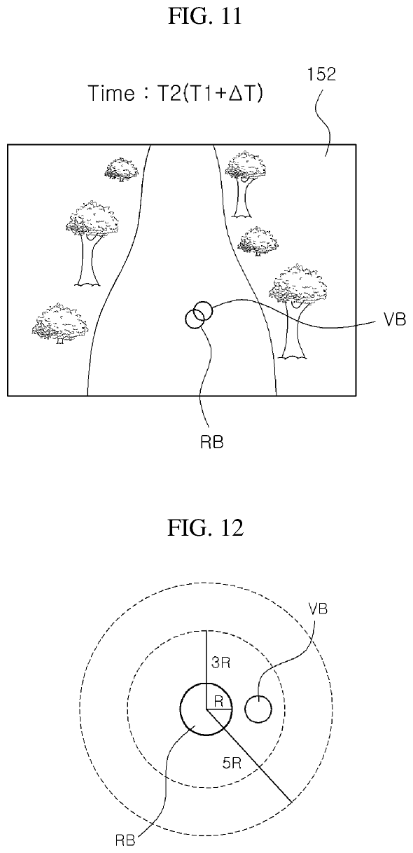

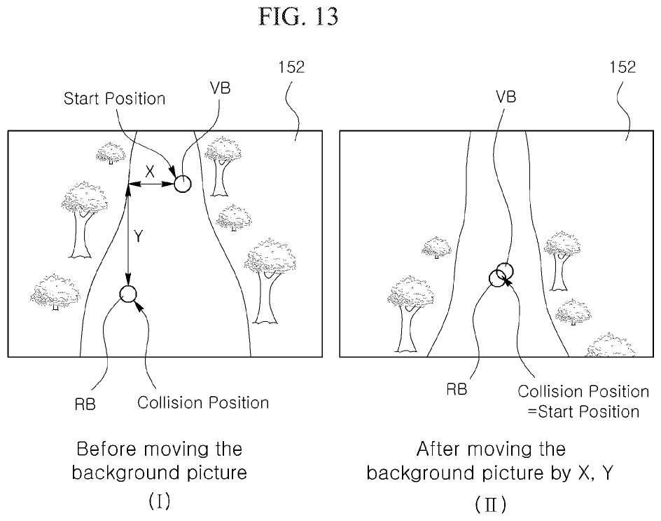

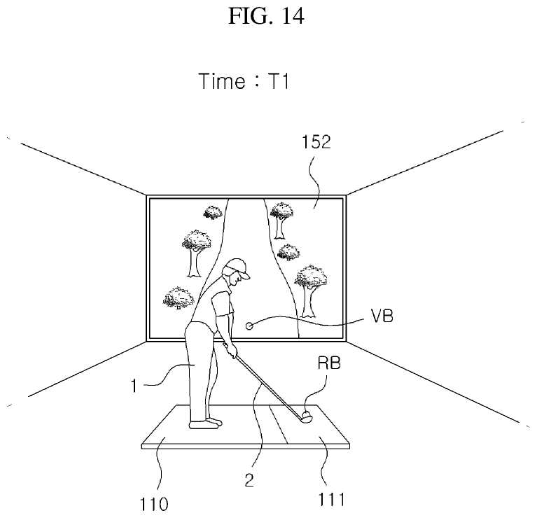

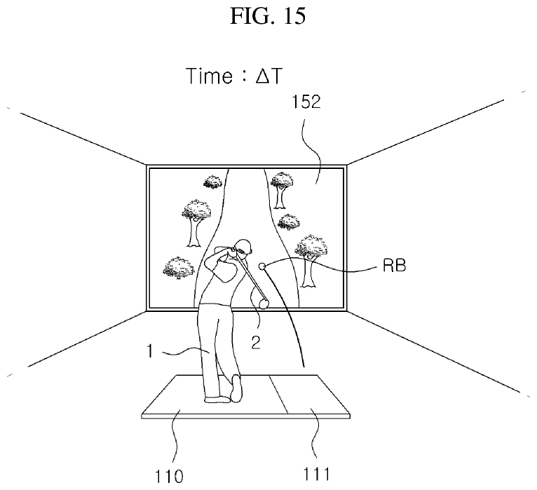

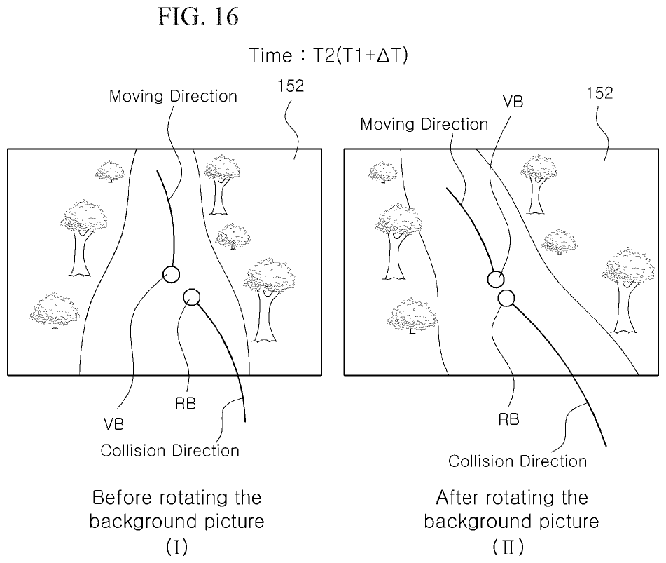

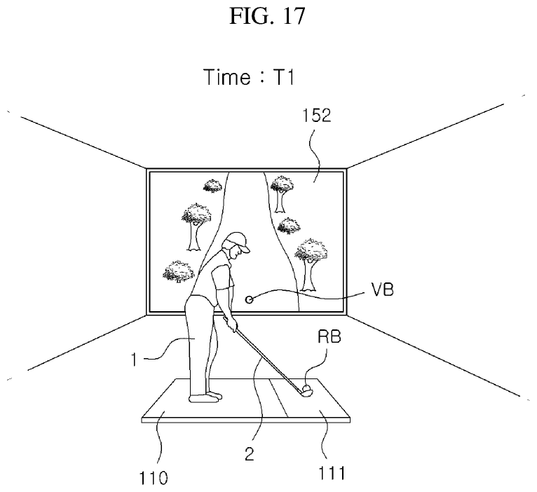

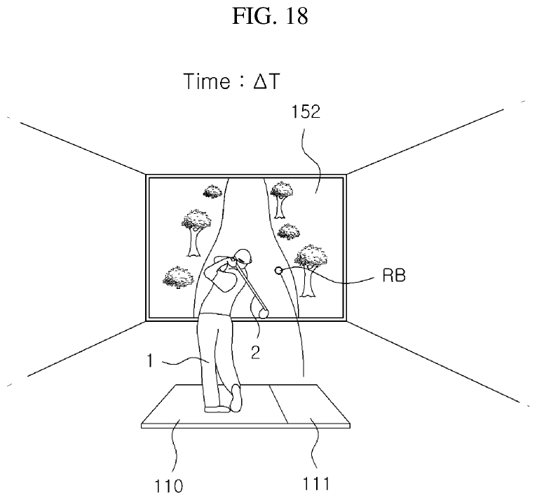

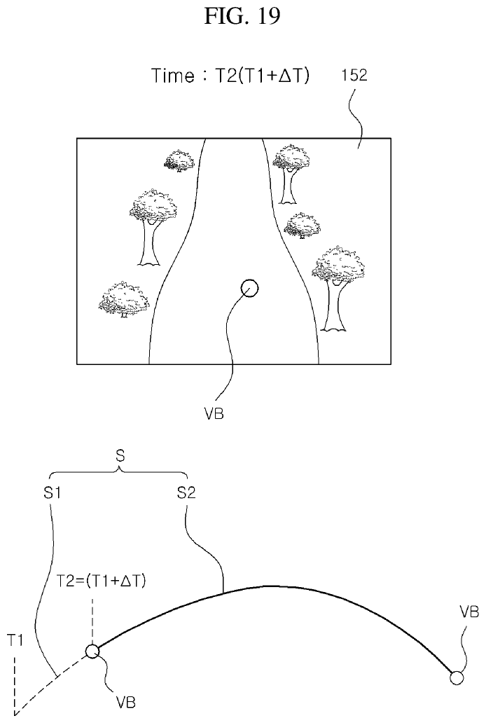

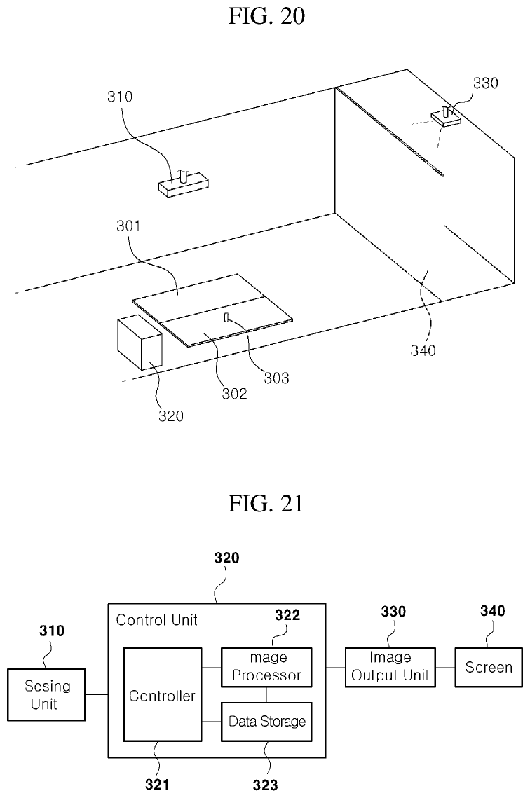

FIG. 20 shows a schematic structure of a virtual golf simulation device using a transmission type screen according to another embodiment of the present inventive concept, and FIG. 21 shows a relationship between main components of the virtual golf simulation device of FIG. 20.

Referring to FIGS. 20 and 21, the virtual golf simulation device comprises a sensing unit 310, a control unit 320, an image output unit 330 and a screen 340. The virtual golf simulation device is installed in a booth for providing a user a screen golf service, and as shown in FIG. 20, a hitting plate 301 for the user's hit is provided in the booth where the sensing unit 310, the control unit 320, the image output unit 330 and the screen 340 of the virtual golf simulation device are installed. A hitting mat 302 where a golf ball for the hit is placed is provided in the hitting plate 301. An auto tee 303 which is vertically movable is installed at the hitting mat 302, a golf ball for the hit is provided to the user through the auto tee 303.

The sensing unit 310 is installed near the hitting plate 301, and senses the movement of the golf ball hit by the user to detect overall state information about the hit golf ball. As the sensing unit 310, a camera capable of sensing the movement of the golf ball can be used. In addition, if it can sense the movement of the golf ball, any sensing means such as a sensor can be used as the sensing unit 310. The camera or the sensor may be used alone or used together, and only one sensing unit may be used or several sensing units may be used if circumstances need.

The control unit 320 comprises a controller 321, an image processor 322 and data storage 323. The controller 321 performs actions related to various calculations for the virtual golf simulation and control between components of the virtual golf simulation device. For example, the controller 321 receives the overall state information about the hit golf ball from the sensing unit 310 when the user hits the golf ball, and then computes the trajectory of the golf ball based on the received information by simulation. In particular, the virtual golf simulation device of the present embodiment adopts a unique operation method (see sixth to tenth operation methods to be described later) in order to give a strong realistic feel to the user, the controller 321 plays a predetermined role in these operations. The image processor 322 performs actions needed to make images about virtual golf simulation such as an image of a virtual golf course, a moving image of a golf ball, an image for menu selection and the like by using data stored in the data storage 323. The data storage 323 stores data necessary for the operations of the controller 321 and the image processor 322. For example, the data storage 323 can store data about the whole view of the virtual golf course and the geographical feature of the virtual golf course, and data needed to compute the trajectory of the virtual golf ball. In addition, the data storage 323 can store user data such as personal information, record information and the like. The data storage 323 may be provided inside the controller 320 as illustrated in FIG. 21, or may be provided in a central server unlike that shown in FIG. 21. A service provider of screen golf may provide this screen golf service to a user in a plurality of screen golf places that can be connected to a central server through a wired/wireless communication network. In this case, the data storage 323 may be provided in the central server so that the data storage 323 can be used in all screen golf places.

The image output unit 330 projects images such as a virtual golf course, a virtual golf ball and the like onto the screen 340. As the image output unit 330, a device such as a beam projector can be used. The screen 340 displays images projected by the image output unit 330 to provide them to the user. The virtual golf course displayed on the screen 340 may have various areas like real golf course. For example, the virtual golf course may include a fairway, a rough, a bunker, a water hazard and the like.

As shown in FIG. 20, when the image output unit 330 is disposed opposite the hitting plate 301 with the screen 340 interposed therebetween, the screen 340 operates in a ‘transmission type’ operation way. The user located at the hitting plate 301 sees the image projected from the image output unit 330 on the opposite side of the image output unit 330. Unlike that illustrated in FIG. 20, when the image output unit 330 and the hitting plate 301 are disposed on the same side with respect to the screen 340, the screen 340 operates in a ‘reflection type’ operation way.

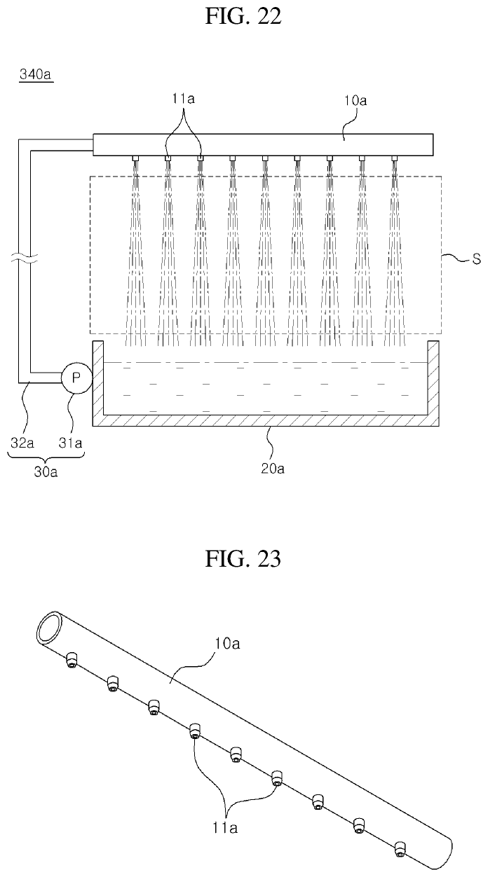

According to an embodiment of the present inventive concept, a transmission type screen can be used as a screen. In this case, if the golf ball hit by the user collides with the screen 340, the golf ball passes through the screen 340. Some examples of this transmission type screen are disclosed in prior art such as Korean Patent No. 10-0972822 B1, and the transmission type screen disclosed in the prior art may be applied to the screen 340 of the present inventive concept. The transmission type screen disclosed in Korean Patent No. 10-0972822 B1 includes a screen member with a plurality of transmission slits disposed side by side, and a golf ball can pass between the transmission slits. However, there is a problem in the transmission type screen of Korean Patent No. 10-0972822 B1. When reaching the screen, if the golf ball passes between the transmission slits it can pass through the screen, but if the golf ball collides with the transmission slit itself it cannot pass through the screen. Therefore, as the screen 340 according to the present embodiment, it is preferable to use another screen capable of ensuring 100% penetration of the golf ball, and this will be described with reference to FIGS. 22 to 25.

Although not shown in FIGS. 20 and 21, an input unit and a voice processing unit may be provided in the virtual golf simulation device. The input unit receives various information from the user, and a keyboard, a mouse and the like can be used as this input unit. In the screen golf, the information input by the user is needed for various cases. For example, when inputting the password or ID of the user, or selecting a play difficulty level, the user needs to input the related information. The input unit is needed for this object. In addition, the voice processing unit is needed to inform the user of the progress of the game and to play various sound effects in accordance with the progress of the game.

FIG. 22 is shows a configuration of a liquid screen as an example of a screen that can be used in the virtual golf simulation device of FIG. 20, and FIG. 23 shows a detailed structure of a spray part in the liquid screen of FIG. 22.

Referring to FIG. 22, the screen 340a according to the present embodiment is a liquid screen displaying an image through a screen film using liquid, and comprises a spray part 10a, a recovery part 20a and a supply part 30a. The spray part 10a includes a plurality of nozzles 11a formed in a spray pipe (see FIG. 23). Liquid passing through the spray pipe at a high pressure is sprayed at a bubble state through a nozzle 11a so that an opaque white water film is formed to form a screen film S. The liquid is sprayed downward from the nozzle 11a and recovered at the recovery part 20a located below. Although FIG. 22 illustrates a configuration where the liquid is sprayed from the top to the bottom, another configuration is possible. For example, the liquid can be sprayed from the bottom to the top, from the left to the right, from the right to the left. In addition, a combination of the above examples where the liquid can be sprayed simultaneously in various directions is possible. The recovery part 20a store the liquid, and a water tank or a reservoir may be used as the recovery part 20a. The liquid stored in the recovery part 20a may include not only liquid recovered after being sprayed from the nozzle 11a but also liquid supplied from an external separate source (not shown in the drawing). The liquid stored in the recovery part 20a is provided to the spray part 10a by the supply part 30a. The supply part 30a includes a pump 31a and a supply pipe 32a. The liquid stored in the recovery part 20a moves along the supply pipe 32a by the operation of the pump 31a to be provided to the spray part 10a. The liquid screen 340a can supply or block liquid to the spray part 10a by controlling whether the pump 31a is turned on or off using a separate control module. As a result, the liquid screen 340a can control the spray of the liquid in the spray part 10a so that the liquid can be sprayed to form the screen film S only when necessary.

The liquid screen 340a described above is one example of various liquid screens applicable to the present inventive concept, and the screen of the present inventive concept is not limited to the above described liquid screen 340a.

If the liquid screen 340a described above is used for screen golf, the golf ball passes through the liquid screen 340a to move forward when the golf ball hit by the user collides with the liquid screen 340a. When using a screen according to the prior art, the golf ball bounces back from the screen to be scattered on the floor after the collision with the screen. Therefore, the play environment is not comfortable due to the golf balls scattered on the floor as the play proceeds. If using the liquid screen 340, this problem can be solved.

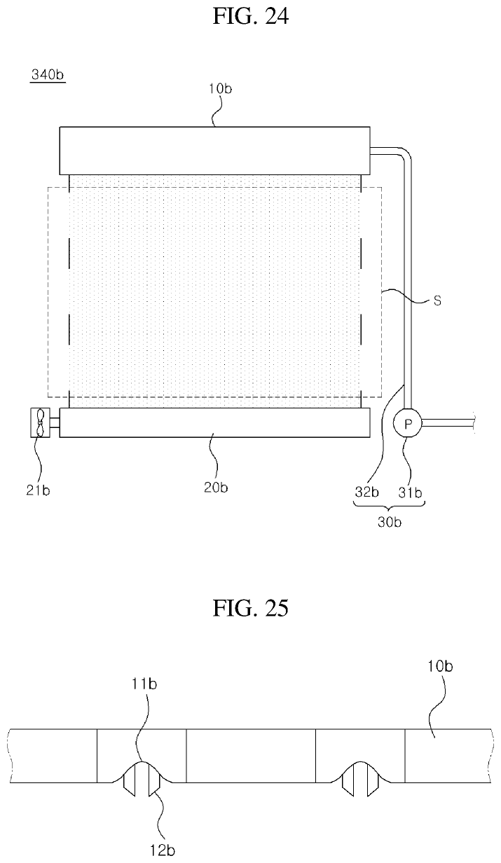

FIG. 24 is shows a configuration of a mist screen as an example of a screen that can be used in the virtual golf simulation device of FIG. 20, and FIG. 25 shows a detailed structure of a spray part in the mist screen of FIG. 24.

Referring to FIG. 24, the screen 340b according to the present embodiment is a mist screen displaying an image through a screen film using mist, and comprises a spray part 10b, a recovery part 20b and a supply part 30b. The spray part 10b sprays mist, and includes a plurality of discharge holes 11b formed in a spray pipe and a plurality of guides 12b each of which protrudes downward at the discharge hole 11b (see FIG. 25). The guide 12b guides the mist sprayed from the discharge hole 11b, and for this purpose, a spray piece with a round shape may be inserted into the discharge hole 11b or installed at the discharge hole 11b to be fixed thereat. The shape and structure of the guide 12b is not limited to that shown in FIG. 25, and the guide 12b is not essential and thus may be omitted. The mist sprayed from the spray part 10b moves downward to form a screen film S and is recovered at the recovery part 20b. There is a suction fan 21b at one side of the recovery part 20b. The mist can be easily recovered at the recovery part 20b by the suction force formed by the suction fan 21b and then discharged to the outside. The supply part 30b includes a pump 31b and a supply pipe 32b. The liquid for forming the mist moves along the supply pipe 32b from the outside by the operation of the pump 31b to be provided to the spray part 10b. The liquid is pumped as high pressure water by the pump 31b to be sprayed in the form of mist at the spray part 10b. Or mist can be generated from the liquid moving along the supply pipe 32b by heating the supply pipe 32b with a separate heater (not shown in the drawing), and then be sprayed at the spray part 10b.

The mist screen 340b described above is one example of various mist screens applicable to the present inventive concept, and the screen of the present inventive concept is not limited to the above described mist screen 340b.

If the mist screen 340b described above is used for screen golf, the golf ball passes through the mist screen 340b to move forward when the golf ball hit by the user collides with the mist screen 340b. When using a screen according to the prior art, the golf ball bounces back from the screen to be scattered on the floor after the collision with the screen. Therefore, the play environment is not comfortable due to the golf balls scattered on the floor as the play proceeds. If using the mist screen 340b, this problem can be solved. In addition, in comparison with a conventional screen, there are advantages that the mist screen 340b can not only produce precise images but also be easily installed in a narrow space.

In addition to using the liquid screen or the mist screen, the virtual golf simulation device can give the feeling that the ball hit by the user is sucked into the screen after the collision between the ball and the screen to be displayed on the screen by using specific operation method. The specific operation method for achieving this effect will be described below.

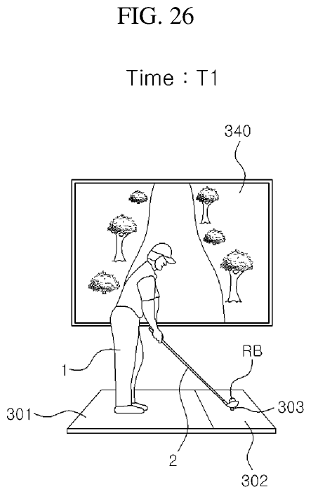

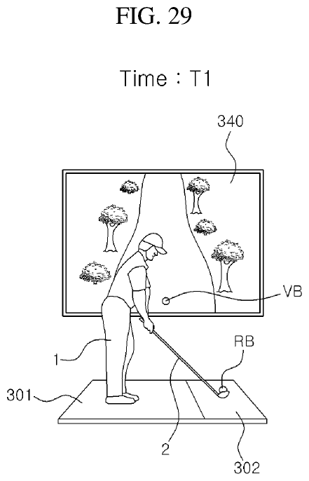

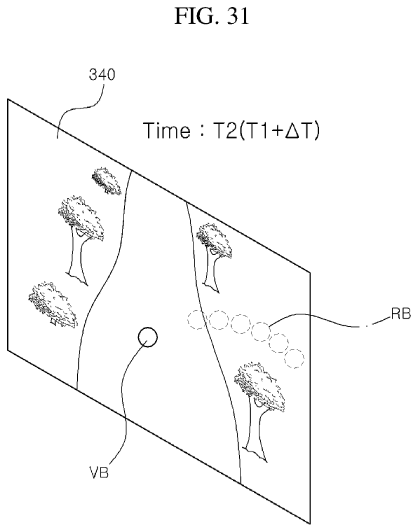

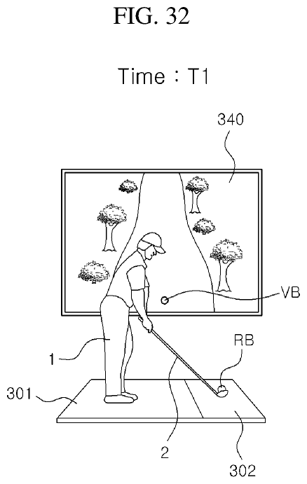

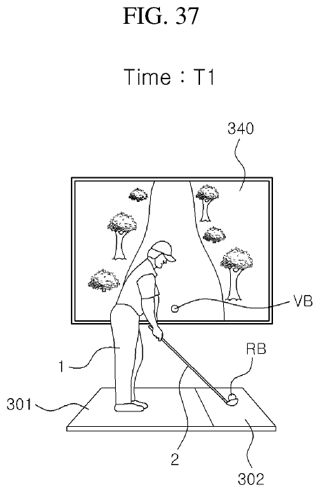

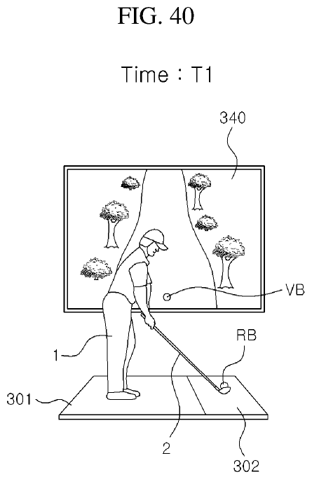

FIGS. 26 to 42 are views for describing examples of various operating methods of the virtual golf simulation device of FIG. 20. FIGS. 26 to 28 show a sixth operation method, FIGS. 29 to 31 show a seventh operation method, FIGS. 32 to 36 show an eighth operation method, FIGS. 37 to 39 show a ninth operation method, and FIGS. 40 to 42 show a tenth operation method.

### Sixth Operation Method

Referring to FIG. 26, a screen golfer 1 is located at the hitting plate 301 with a golf club 2 and a real golf ball RB is placed on the auto tee 303 of the hitting mat 302. In FIG. 26, the golf club 2 is contact with the real golf ball RB, and this moment is when or just before the screen golfer 1 hits the ball for a tee off.

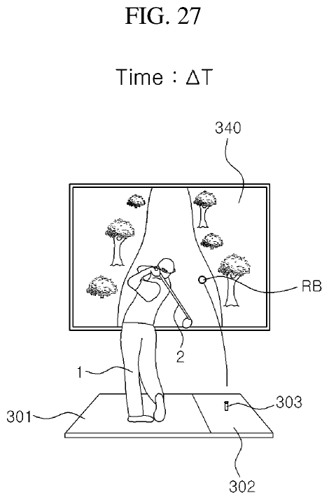

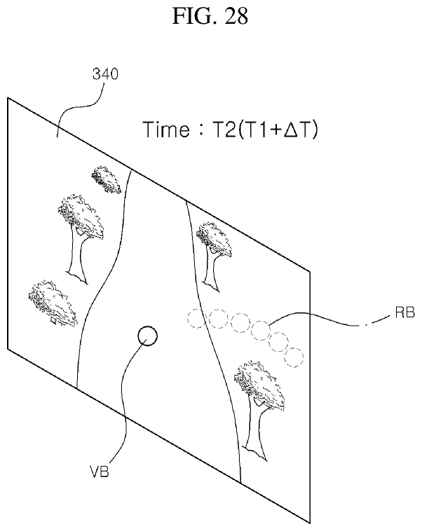

Referring FIGS. 27 and 28, the screen golfer 1 completes the swing, and the hit golf ball RB moves forward and collides with the screen 340. When the real golf ball RB collides with the screen 340, the virtual golf ball VB is displayed on the screen 340 after the collision. Even if the virtual golf ball VB is displayed immediately after the collision, it may be shown with the naked eye that the virtual golf ball VB is displayed at the same time as the collision. Therefore, there is no significant difference between displaying the virtual golf ball VB at the same time as the collision and displaying the virtual golf ball VB immediately after the collision in that it is not distinguished with the naked eye. What is described as ‘after the collision’ herein may even include ‘at the same time as the collision’ in some cases.

As described above, the virtual golf simulation device according to the present embodiment is characterized in that the virtual golf ball VB is not displayed on the screen 340 immediately after the real golf ball RB is hit (see FIG. 27), and the virtual golf ball VB is displayed on the screen 340 immediately after the real golf ball RB reaches the screen 340.

In other words, if the time point when the real golf ball RB is hit is called a first time T1, the time period taken for the real golf ball RB to fly at the first time T1 and reach the screen 340 is called a flight time ΔT, and the time point when the real golf ball RB collides with the screen 340 is called a second time T2 (T2=T1+ΔT), the operational feature according to the present embodiment is that the virtual golf ball VB is not displayed on the screen 340 during the flight time ΔT.

The effect of this feature is as follows.

Real and virtual worlds are mixed in the screen golf. The action that the screen golfer 1 actually hits the real golf ball RB represents the real world since this action is not different with a hit action made in an outdoor golf course. On the other hand, the movement of the golf ball after hitting the golf ball represents the virtual world since the movement of the golf ball is not made by the real golf ball RB and is shown by the virtual golf ball VB in the screen 340. If the virtual golf ball VB is displayed on the screen 340 during the flight time ΔT, the screen golfer 1 becomes indifferent about how the real golf ball RB moves after hitting the real golf ball RB and pays attention to only the movement of the virtual golf ball VB displayed on the screen 340. That is, before and after hitting the real golf ball RB, the interest of the screen golfer 1 is suddenly switched from the real world to the virtual world. If the interest of the screen golfer 1 is suddenly switched like this, the real world and the virtual world are disconnected from each other and the gap therebetween is increased. As a result, it is difficult for the screen golfer 1 to feel as if playing real sports games in the outdoor golf course.

However, if the virtual golf ball VB is not displayed on the screen 340 during the flight time ΔT according to the present embodiment, the screen golfer 1 pays attention to not the screen 340 but the movement of the real golf ball RB even after hitting the real golf ball RB. When the real golf ball RB reaches the screen 340, the eye of the screen golfer 1 is naturally moved to the screen 340, and thus the screen golfer pays attention to the movement of the virtual golf ball VB displayed on the screen 340 at that moment. As a result, the interest of the screen golfer 1 naturally flows from the real world to the virtual world to reduce the gap between the real world and the virtual world. Therefore, it makes the screen golfer 1 strongly feel as if playing real sports games in the outdoor golf course.

In particular, since the transmission type screen is used as the screen 340 according to the present embodiment, as shown in FIG. 28, the real golf ball RB passes through the screen 340 after reaching the screen 340 to move further from the screen 340 and disappear from the view of the screen golfer 1. If this sixth operation method is applied to the screen of the prior art, the golf ball bounces back the screen after colliding with the screen and remains in the user's view. However, if this sixth operation method is applied to the transmission type screen, since the real golf ball RB reaches the screen 340 to disappear and at the same time the virtual golf ball VB is displayed on the screen 340, it can give the strong feeling that the real golf ball RB reaches the screen 340 and then is sucked into the screen 340 to be displayed as the virtual golf ball VB on the screen 340.

According to the present operation method, since the virtual golf ball VB beings to be displayed after the real golf ball RB collides with the screen 340, it is necessary to detect the collision between the real golf ball RB and the screen 340. Therefore, a detection sensor for detecting the collision between the real golf ball RB and the screen 340 is required. Although not shown in the drawing, as one example of the detection sensor, a visual sensor such as a camera that can visually detect the collision between the real golf ball RB and the screen 340 may be used. This visual sensor can detect not only whether or not the real golf ball RB collides with the screen 340, but also additional information such as the collision position, the collision direction meaning the moving direction of the real golf ball RB at the time of the collision. This additional information may be used in seventh to tenth operations described later. However, even though there is no detection sensor, it is possible to get the additional information through calculation if it is necessary. For example, after the screen golfer 1 hits the real golf ball RB, the state of the real golf ball RB such as speed, spin and the like is sensed in order to compute the trajectory of the virtual golf ball RB, and the above mentioned information such as the collision time, the collision position, the collision direction and the like can be calculated from the sensed information about the state of the hit real golf ball RB.

Since the present operation method presupposes that the real golf ball RB reaches the screen 340, if the real golf ball RB hit by the screen golfer 1 does not reach the screen 340, the conventional operation method can be used instead of the present operation method.

### Seventh Operation Method

Referring to FIG. 29, the screen golf player 1 hits the real golf ball RB at the first time T1. When comparing with FIG. 26, there is a difference in that the real golf ball RB is placed on the hitting mat 302. In the case of the tee off, the golf player 1 hits the real golf ball RB placed on the auto tee (see reference numeral 303 in FIG. 26). However, in the case of the hit except for the tee off, the golf player 1 hits the real golf ball RB placed on the hitting mat 302. When comparing with FIG. 26, there is another difference in that the virtual golf ball VB is displayed on the screen 340. FIG. 29 shows a state in which the screen golfer 1 makes a play after the tee off. In this state, the virtual golf ball VB is located at various regions (fairway, rough, bunker, etc.) on the virtual golf course depending on how the screen golfer 1 has played. As shown in FIG. 29, the virtual golf ball VB is displayed on the screen 340, and thus the screen golfer 1 can clearly know where the virtual golf ball VB corresponding to the real golf ball RB is currently located before hitting the real golf ball RB.

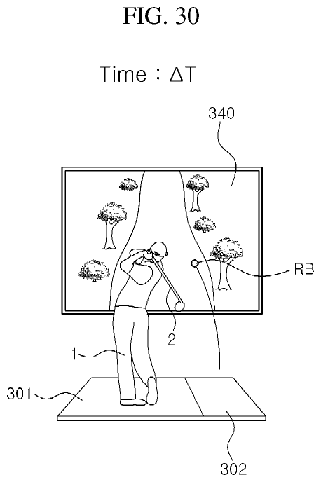

Referring to FIG. 30, immediately after the screen golfer hit the real golf ball RB, the virtual golf ball VB disappears from the screen 340 and then the virtual golf ball VB is not displayed on the screen 340 during the flight time between the first time T1 and when the real golf ball RB collides with the screen 340.

Referring to FIG. 31, the real golf ball RB reaches the screen 340 at the second time T2 and then passes through the screen 340. The virtual golf ball VB is displayed again on the screen 340 at the same time as the second time T2 or immediately after the second time T2. This is identical to the sixth operation method shown in FIG. 28.

According to this embodiment, the virtual golf ball VB is displayed on the screen 340 before the real golf ball RB is hit so that the screen golfer 1 can clearly know where the virtual golf ball VB is located before hitting the real golf ball RB. In addition, by not displaying the virtual golf ball VB on the screen 340 for the flight time ΔT after hitting the real golf ball RB, it induces the screen golfer 1 to pay attention to the real golf ball RB instead of immediately averting her/his eyes to the screen 340. As a result, like the case of the sixth operation method, the gap between the real world and the virtual world is reduced and thus the screen golfer 1 can feel as if playing real sports outside.

### Eighth Operation Method

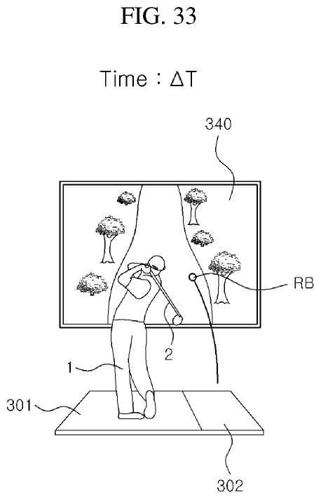

Referring to FIGS. 32 and 33, the operation at the first time T1 and during the flight time ΔT is identical to the seventh operation method. That is, the virtual golf ball VB is displayed on the screen 340 at the first time point T1, and the virtual golf ball VB disappears from the screen 340 after the first time T1 and is not displayed during the flight time ΔT. Herein, it is possible that the operation at the first time T1 and during the flight time ΔT is modified to be similar to the sixth operation method so that the virtual golf ball VB is not displayed on the screen 340 from the first time T1.

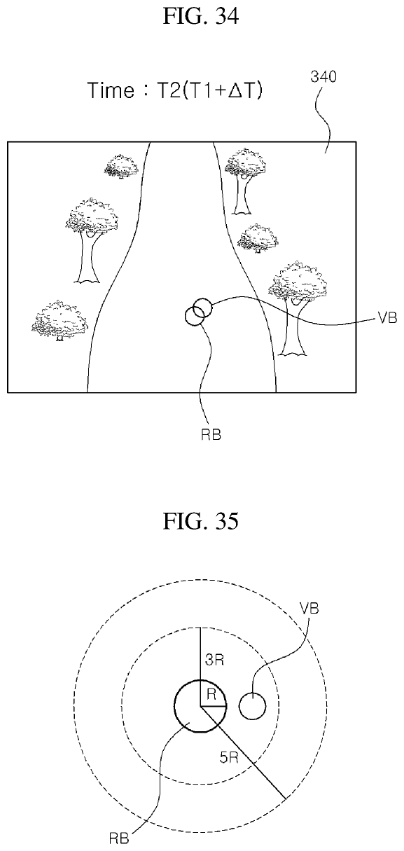

Referring to FIG. 34, the real golf ball RB reaches the screen 340 at the second time T2 and then passes through the screen 340. The virtual golf ball VB is displayed on the screen 340 at the same time as the second time T2 or immediately after the second time T2. In addition, the virtual golf ball VB begins to be displayed at the same position where the real golf ball RB collides with the screen 340 (In FIG. 34, the position of the virtual golf ball VB and the position of the real golf ball RB do not completely coincide with each other. FIG. 34 is intentionally drawn like this, considering that if two golf balls RB and VB overlap in FIG. 34, any one ball will be covered by the other ball to be invisible).

If the virtual golf ball VB appears on the screen 340 at the position where the real golf ball RB collides with the screen 340, it can give a feeling that, after the collision with the screen 340, the real ball RB is sucked into the screen 340 to be displayed as the virtual golf ball VB on the screen 340. As a result, the gap between the real world and the virtual world is greatly reduced and the user can strongly feel as if playing real sports outside.

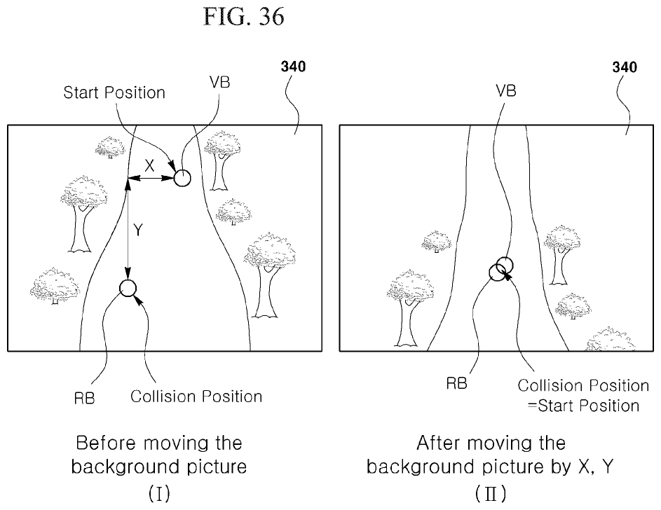

FIGS. 35 and 36 show a modified example of the eighth operation method, respectively.

Referring to FIG. 35, the virtual golf ball VB begins to be displayed near the position where the real golf ball RB collides with the screen 340 (Hereinafter, the position where the real golf ball RB collides with the screen 340 is called ‘collision position’, and the position where the virtual golf ball VB starts to be displayed on the screen 340 after the real golf ball RB collides with the screen 340 is called ‘start position’). In order to give a feeling that the real ball RB is sucked into the screen 340 after the collision with the screen 340, it is preferable that the start position is identical to the collision position. However, it is not easy to make the start position and the collision position accurately coincide with each other. Since the size of the golf ball is not large, even if the virtual golf ball VB is displayed near the collision position, it is not easy to recognize that the start position is not different with the collision position with the naked eye. Therefore, it is preferable that the virtual golf ball VB is displayed near the collision point within a range where a person with average eyesight cannot recognize that the start position is not different with the collision position. Considering that this range may vary from person to person, as shown in FIG. 35, when the radius of the real golf ball RB is ‘R’, it is preferable that the start position is in the range of about 5R from the center of the golf ball RB. It is more preferable that the start position is in the range of about 3R.

Referring to FIG. 36, the background picture of the screen 340 is displayed on the screen 340 after moving horizontally and/or vertically at the time T2. In the eighth operation method, the virtual golf ball VB begins to be displayed on the screen 340 at or near the collision position where the real golf ball RB collided with the screen 340. Considering that the trajectory of the virtual golf ball VB is determined by the computation through the simulation of the controller (see reference numeral 320 in FIG. 21) and the start position where the virtual golf ball VB starts to be displayed is dependent on a position where the virtual ball is initially located in the simulated trajectory, it is likely that the start position is different the collision position. In order to match the start position with the collision position, the collision position must be moved to the start position or the start position must be moved to the collision position.

When the player hits the real golf ball RB, the real golf ball RB moves along the trajectory of the real golf ball RB formed based the player's hit to collide with the screen 152 and thus the collision position is determined. In this way, the collision position is dependent on the player's hit and cannot be changed arbitrarily. Therefore, it is impossible to move the collision position to the start position. In the case of the start position, since it is determined according to the trajectory computed through the simulation of the controller 321, it cannot be arbitrarily changed. However, it is possible to relocate the start position on the screen 340 by moving the background picture in the screen 340 as shown in FIG. 36. By using this way, it is possible to make the start position where the virtual golf ball VB starts to be displayed on the screen 340 corresponds to the collision position where the real golf ball RB collides with the screen 340.

For example, before moving the background picture of the screen 340, the start position and the collision position are different by ‘X’ in the horizontal direction and ‘Y’ in the vertical direction as shown in FIG. 36 (I). According to this operation method, the start position and the collision position become the same position by moving the background picture by ‘X’ in the horizontal direction and ‘Y’ in the vertical direction as shown in FIG. 36 (II) (In FIG. 36 (II), the position of the virtual golf ball VB and the position of the real golf ball RB do not completely coincide with each other. FIG. 36 (II) is intentionally drawn like this, considering that if two golf balls RB and VB overlap in FIG. 36 (II), any one ball will be covered by the other ball to be invisible).

As described above, the present modified example shows the operation method of matching the collision position with the start position by vertically and/or horizontally moving the background picture displayed on the screen 340.

### Ninth Operation Method

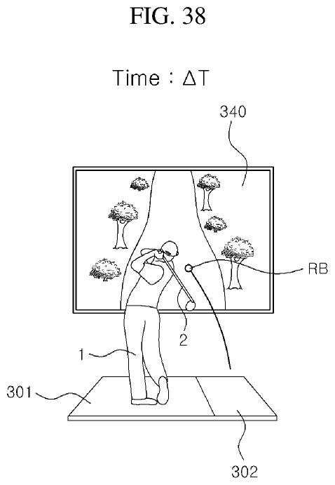

Referring to FIGS. 37 and 38, the operation at the first time T1 and during the flight time ΔT is identical to the second operation method. That is, the virtual golf ball VB is displayed on the screen 340 at the first time T1, and the virtual golf ball VB disappears from the screen 340 after the first time T1 and is not displayed during the flight time ΔT. Herein, it is possible that the operation at the first time T1 and during the flight time ΔT is modified to be similar to the sixth operation method so that the virtual golf ball VB is not displayed on the screen 340 from the first time T1.

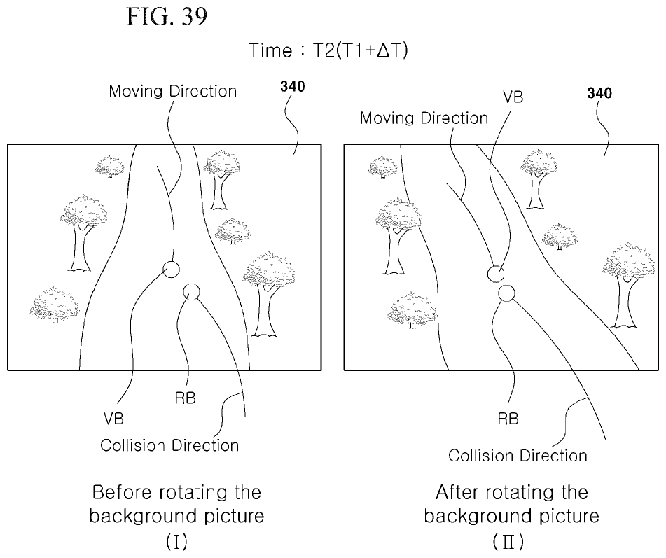

Referring to FIG. 39, at the second time T2 when the real golf ball RB collides with the screen 340 or immediately after the second time T2, the virtual golf VB is displayed on the screen 340 and an angle where the background picture is viewed on the screen 340 is changed in order that the angle corresponds to a direction where the real ball RB collides with the screen 340.

As shown in FIG. 39 (I), if the collision direction (hereinafter, referred to as ‘collision direction’) where the real golf ball RB collides with the screen 340 differs greatly from the moving direction (hereinafter, referred to as ‘moving direction’) where the virtual golf ball VB displayed on the screen 340 moves, it can give the screen golfer 1 an unnatural feeling that the real golf ball RB is sucked into the screen 340 to be suddenly refracted in its direction. In order to prevent this unnatural impression, it is preferable to match the collision direction where the real golf ball RB collides with the screen 340 and the moving direction where the virtual golf ball VB displayed on the screen 340 moves.

The movement of the real golf ball RB is dependent on the player's hit and cannot be changed arbitrarily. Likewise, the moving direction of the virtual golf ball VB cannot be arbitrarily changed. However, as shown in FIG. 39 (II), it is possible to change a viewing angle where the background picture is viewed on the screen 340. Changing the viewing angle has the same effect as changing the direction where the virtual golf ball VB moves on the screen 340. By using this way, it is possible to match the moving direction where the virtual golf ball VB displayed on the screen 340 moves and the collision direction where the real golf ball RB collides with the screen 340.

### Tenth Operation Method

The present operation method is related to how to simulate and compute the trajectory of the virtual golf ball VB to be displayed on the screen 340. The present operation method is different from the previous operation methods in that results according to this operation method are not clearly revealed to the screen golfer 1. The present operation method can be used alone or used in combination with at least one of the sixth to ninth operation methods. FIGS. 40 to 42 show an example that the present operation method is used in combination with the seventh operation method.

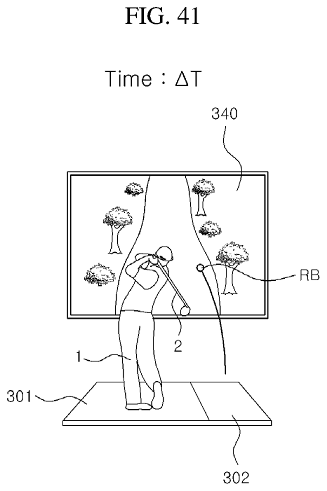

Referring to FIGS. 40 and 41, the operation at the first time T1 and during the flight time ΔT is identical to the seventh operation method. That is, the virtual golf ball VB is displayed on the screen 340 at the first time T1, and the virtual golf ball VB disappears from the screen 340 after the first time T1 and is not displayed during the flight time ΔT. Herein, it is possible that the operation at the first time T1 and during the flight time ΔT is modified to be similar to the sixth operation method so that the virtual golf ball VB is not displayed on the screen 340 from the first time T1.

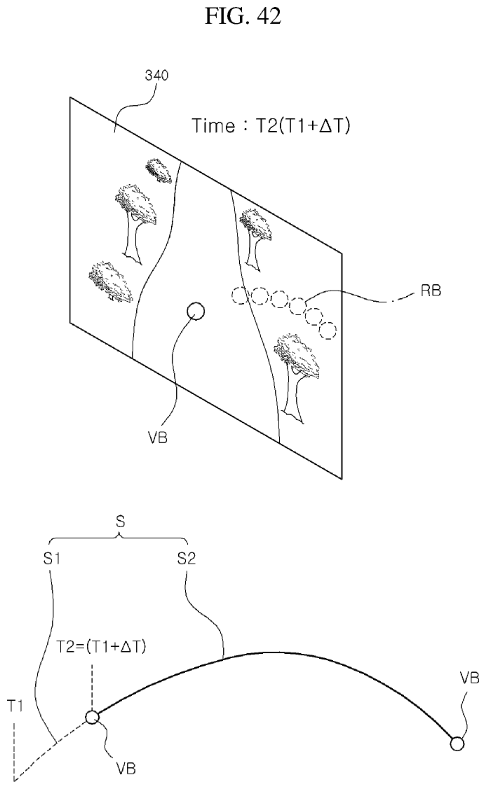

Referring to FIG. 42, at the second time T2 when the real golf ball RB collides with the screen 340 or immediately after the second time T2, the virtual golf VB is displayed on the screen 340. The technical feature of this operation method relates to the trajectory of the virtual golf ball VB displayed on the screen 340. Concretely, when the real golf ball RB is hit at the first time T1 and the trajectory S for the virtual golf ball VB is computed as a result of the simulation based on the result of the player's hit, and furthermore when the trajectory S includes a trajectory S1 corresponding to a trajectory between the first time T and a predetermined time and a trajectory S2 corresponding to a trajectory after the predetermined time, what is actually displayed on the screen 340 in the trajectory S is only the trajectory S2 except for the trajectory S1 according to the this operation method. For example, the predetermined time may be the second time T2 representing when the real golf ball RB collides with the screen 340. In this case, the trajectory S1 corresponds to a trajectory during the flight time ΔT (between the first time T1 and the second time T2) and the trajectory S2 corresponds to a trajectory after the second time T2, and only the trajectory S2 is displayed on the screen 340. That is, the virtual golf ball VB moving along the trajectory S1 is not displayed and the virtual golf ball VB moving along the trajectory S2 only is displayed.

Considering that the real golf ball RB flies from the hitting zone to the screen 340 during the flight time ΔT and the trajectory S1 corresponds to a trajectory during the flight time ΔT, the trajectory S1 is replaced by the real trajectory by the real golf ball RB flying to the screen 340 by omitting and not displaying the trajectory S1 of the entire simulated trajectory S in the present operation method. Therefore, the entire trajectory is represented by the real golf ball RB outside the screen 340 and the virtual golf ball VB in the screen 340. That is, the movement of the real golf ball RB is naturally connected to the movement of the virtual golf ball VB on the screen 340 and the trajectory of the real golf ball RB is also connected to the trajectory of the virtual golf ball VB. As a result, the screen golfer 1 can feel as if the real ball RB is sucked into the screen 340 and strongly feel as if playing real sports games in the outdoor golf course.

In particular, since the transmission type screen is used as the screen 340 according to the present embodiment, as shown in FIG. 42, the real golf ball RB passes through the screen 340 after reaching the screen 340 to move further from the screen 340 and disappear from the view of the screen golfer 1. If this operation method is applied to the screen of the prior art, the golf ball bounces back the screen after colliding with the screen and remains in the user's view. However, if this operation method is applied to the transmission type screen, since the real golf ball RB collides with the screen 340 to disappear and at the same time the virtual golf ball VB is displayed on the screen 340, it can give the strong feeling that the real golf ball RB reaches the screen 340 and then is sucked into the screen 340 to be displayed as the virtual golf ball VB on the screen 340.

As above, although specific embodiments of the present inventive concept have been described, those skilled in the art will appreciate that the present inventive concept may be embodied in other specific ways without changing the technical spirit or essential features thereof. For example, the first to tenth operation methods can be applied not only to screen golf but also to screen baseball and other virtual sports devices. In addition, the sixth to tenth operating methods are not only used separately but also used in combination thereof. For example, the operation method of moving the background picture in order to match the start position with the collision position (see FIG. 36 and related description) can be combined with the operation method of rotating the background picture in order to match the moving direction with the collision direction (see FIG. 39 and related description).

The embodiments disclosed herein are not restrictive but are illustrative. The scope of the present inventive concept is given by the claims, rather than the specification, and also contains all modifications within the meaning and range equivalent to the claims.

### INDUSTRIAL APPLICABILITY

According to a virtual sports simulation device of the present inventive concept, the gap between a real world and a virtual world is reduced and a user can feel as if playing real sports outside by giving the feeling that a ball hit by the user penetrate a screen after the collision between the ball and the screen, and is sucked into the screen to be displayed on the screen.

1. A virtual sports device comprising:
a control part for computing a trajectory of a virtual ball based on a real ball hit by a user; and
a screen for displaying the virtual ball moving along the computed trajectory, wherein the virtual ball moving along the computed trajectory is displayed on the screen after the real ball hit by the user collides with the screen.

2. The virtual sports device of claim 1, wherein the screen displays a background picture for a virtual sport, and the background picture moves horizontally and/or vertically when the real ball collides with the screen.

3. A virtual sports device comprising:
a control part computing a trajectory of a virtual ball based on a real ball hit by a user; and
a screen displaying the virtual ball moving along the computed trajectory, wherein, if a position where the virtual ball is initially located in the computed trajectory is called an initial position and a position where the virtual ball is located in the computed trajectory after a predetermined time elapses is called an intermediate position, the trajectory between the initial position and the intermediate position is not displayed on the screen, and the virtual ball displayed on the screen moves along a trajectory after the intermediate position.

4. (canceled)

5. The virtual sports device of claim 3, wherein the virtual ball is displayed on the screen after the real ball hit by the user collides with the screen.

6. (canceled)

7. (canceled)

8. (canceled)

9. (canceled)

10. (canceled)

11. A virtual sports device comprising:
a control part computing a trajectory of a virtual ball based on a real ball hit by a user; and
a screen displaying the virtual ball moving along the computed trajectory,
wherein the screen is a transmission type screen where the real ball hit by the user can pass.

12. The virtual sports device of claim 11, wherein the transmission type screen is a liquid screen where a screen film is made of liquid or a mist screen where a screen film is made of mist.

13. (canceled)

14. The virtual sports device of claim 11, wherein the virtual ball moving along the computed trajectory is displayed on the screen after the real ball hit by the user collides with the screen.

15. (canceled)

16. The virtual sports device of claim 14, wherein the screen displays a background picture for a virtual sport, and the background picture moves horizontally and/or vertically when the real ball collides with the screen.

17. The virtual sports device of claim 14, wherein the screen displays a background picture for a virtual sport, and an angle where the background picture is viewed on the screen is changed when the real ball collides with the screen.

18. The virtual sports device of claim 14, wherein the virtual ball is displayed on the screen before the user hits the real ball, disappears from the screen after the user hits the real ball, and is displayed on the screen after the real ball hit by the user collides with the screen.

19. The virtual sports device of claim 14, wherein, if a position where the virtual ball is initially located in the computed trajectory is called an initial position and a position where the virtual ball is located in the computed trajectory after a predetermined time elapses is called an intermediate position, the trajectory between the initial position and the intermediate position is not displayed on the screen, and the virtual ball displayed on the screen moves along a trajectory after the intermediate position.

20. (canceled)

21. (canceled)

22. (canceled)

23. (cancelled)

24. (Canceled)

25. (canceled)

26. The virtual sports device of claim 1, wherein the screen displays a background picture for a virtual sport, and an angle where the background picture is viewed on the screen is changed when the real ball collides with the screen.

27. The virtual sports device of claim 1, wherein the virtual ball is displayed on the screen before the user hits the real ball, disappears from the screen after the user hits the real ball, and is displayed on the screen after the real ball hit by the user collides with the screen.

28. The virtual sports device of claim 5, wherein the elapsed time corresponds to time period between when the user hits the real ball and when the real ball collides with the screen.
